(19) United States
(12) Patent Application Publication
(10) Pub. No.: US 2021/0378251 A1
(43) Pub. Date: Dec. 9, 2021

(54) CITRUS FRUIT COLORING RETARDANT AND PREPARATION METHOD AND USE METHOD THEREOF

(71) Applicant: Institute of fruit tree research, guangdong academy of agricultural sciences, Guangzhou (CN)

(72) Inventors: Huaxue YAN, Guangzhou (CN); Yun ZHONG, Guangzhou (CN); Bo JIANG, Guangzhou (CN); Yuanda LV, Guangzhou (CN); Birong ZHOU, Guangzhou (CN)

(73) Assignee: INSTITUTE OF FRUIT TREE RESEARCH, GUANGDONG ACADEMY OF AGRICULTURAL SCIENCES, Guangzhou (CN)

(21) Appl. No.: 17/216,023

(22) Filed: Mar. 29, 2021

(30) Foreign Application Priority Data
Jun. 5, 2020 (CN) 202010507760.7

(51) Int. Cl. A23B 7/10; A23B 7/157

(52) U.S. Cl. CPC A23B 7/10; A23B 7/157

(57) ABSTRACT

The present disclosure discloses a citrus fruit coloring retardant, and the citrus fruit coloring retardant is a prepared indole-3-acetic acid solution with a concentration of 1,000 μM. The citrus fruit coloring retardant is prepared by weighing 3.504 g of indole-3-acetic acid powder, dissolving the powder in 10-15 mL of absolute ethanol, adding an obtained indole-3-acetic acid absolute ethanol solution to 20 L of sterilized distilled water, and mixing evenly to obtain the retardant. In addition, the present disclosure also provides a use method of the citrus fruit coloring retardant. The method for delaying color change of citrus fruits is reliable and stable and suitable for researches on mechanism of citrus fruits ripening in laboratory in laboratory and delay of fruit ripening in production. The citrus fruit coloring retardant is a natural plant hormone, also is low cost, environmentally friendly and non-toxic.

### CROSS REFERENCE TO RELATED APPLICATION

This application claims foreign priority benefits under 35 U.S.C. § 119(a)-(d) to CN Application 202010507760.7 filed Jun. 5, 2020, which is hereby incorporated by reference in its entirety.

### BACKGROUND

The present disclosure relates to the technical field of citrus fruits preservation, and particularly relates to a citrus fruit color-changing retardant and a preparation method and a method of using same.

In a global citrus market that is regularly oversupplied in the harvesting season, the phenomenon of oversupply is more severe when the citrus fruits of mid-maturing varieties are pouring into the market. This brings a serious impact on market supply, demand, price, and greatly affects economic benefits of the industry. Therefore, how to control the maturity period of citrus fruits is one of the key aspects to solve this problem.

Currently, there are two main methods for changing the maturity period of citrus fruits:

1) using compound fertilizers to accelerate maturation and coloring of citrus fruits.

2) improving cultural practices, including heat preservation in winter, irrigation management, fertilizer management, pruning and fruit thinning, to make the citrus fruits mature earlier.

It can be found that the existing methods mainly aim at the promotion of citrus fruits maturation. Economic benefits are improved by putting the citrus fruits into the market earlier to seize the market share. Therefore, how to delay coloring and maturity of citrus fruits is another key to extend shelf life of the citrus fruits and improve economic benefits.

In the prior art, the patent 201711011194.5 discloses a citrus fruits preservative and a preparation method thereof. The citrus preservative includes the following raw and auxiliary materials in weight percentage: 30-50% of starch, 1-3% of benomyl, 1-3% of potassium sorbate, 1-3% of dehydroacetic acid, 1-3% of sodium diacetate, 3-10% of citric acid, 1-5% of indole-3-acetic acid, 2-5% of lemon yellow, 2-5% of (3-carotene, 2-8% of sucrose ester and the balance is water. The citrus preservative can maintain them fresh for a long time, can also enable the treated fruits to continue coloring and be stored for a long time in a post-harvest process without generating peculiar smell. The preservative is low cost and also has good antiseptic function. However, the citrus preservative contains many components and also does not claim a specific long-term storage effect.

Therefore, there is a need for a citrus fruit coloring retardant that is simpler to prepare and operate, and also has an excellent effect.

### SUMMARY

The technical problem to be solved by the present disclosure is to provide a citrus fruit coloring retardant. The citrus fruit coloring retardant can delay degreening of citrus peels and fruit maturation, and prolong the shelf life of fruits. In addition, the present disclosure also provides a preparation method and a method of using the citrus fruit coloring retardant.

To solve the above technical problem, the present disclosure adopts the following technical solutions.

A citrus fruit coloring retardant is a prepared indole-3-acetic acid solution with a concentration of 100-1,000 82 M. A higher concentration of the solution ensures longer delay of coloring of citrus fruits. The concentration of the indole-3-acetic acid solution may preferably be 1,000 μM.

The citrus fruit coloring retardant with the concentration of 1,000 μM is prepared by weighing and dissolving 3.504 g of indole-3-acetic acid (a molecular weight of 175.18) powder in 10-15 mL of absolute ethanol (indole-3-acetic acid is easily soluble in ethanol), adding an obtained indole-3-acetic acid absolute ethanol solution to 20 L of sterilized distilled water, and mixing evenly to obtain the retardant. If it is necessary to prepare the coloring retardant with a lower concentration, the coloring retardant with a high concentration can be diluted proportionally.

After the citrus fruit coloring retardant of the present disclosure is prepared, fruits are processed as follows: full-size green citrus fruits are collected and washed with tap water to remove dust, and then immersed in 0.1% bleaching powder solution for 10 min, and then the fruits are transferred to 0.1% of carbendazim for 10 min after air-drying. They are soaked and washed with sterilized water five times, and the fruits are air-dried at room temperature. The citrus fruits are treated by using a vacuum infiltration method: the fruits are immersed in the coloring retardant indole-3-acetic acid solution, the fruits are placed in a vacuum dryer connected to a portable air compressor, the relative vacuum degree of −15 kPa to −20 kPa is set and maintained for 2 min. Then an intake valve is slowly opened, the indole-3-acetic acid solution is injected into the citrus fruits with an increase in air pressure. The fruits are stored: the treated citrus fruits are placed at a dark place at 25±2° C. and a relative humidity of 50-70%. The citrus fruit coloring retardant can delay color change of citrus fruits for 2 months or more.

Compared with the prior art, the present disclosure has the following beneficial effects:

The use method of the citrus fruit color-changing retardant for delaying degreening of citrus fruits is reliable and stable and suitable for researches on the mechanism of citrus fruits ripening in laboratory and delay of fruit ripening in production. The citrus fruit coloring retardant is low cost, a natural plant hormone, and environmentally friendly and non-toxic. The citrus fruit coloring retardant has less components, has a technical effect of definitely delaying coloring of citrus fruits for at least 25-60 days, also has simple preparation process and low equipment requirements and is suitable for large-scale fruit processing and comprehensive promotion and application, and can achieve great economic benefits. Besides, the color-changing time of citrus fruits can be freely controlled by adjusting the concentration of the coloring retardant.

### BRIEF DESCRIPTION OF THE DRAWINGS

FIG. 1 shows the citrus fruits before treatment, and 25 days and 60 days after different treatments with 100 μM and 1000 μM citrus fruits coloring retardant in the present disclosure.

### DETAILED DESCRIPTION

In order to allow those skilled in the art to understand the present disclosure more clearly and intuitively, the following describes the present disclosure in more detail with reference to the accompanying drawings.

A citrus fruit coloring retardant of the present disclosure is a 1,000 μM of an indole-3-acetic acid (IAA) solution. The citrus fruit coloring retardant is prepared by weighing and dissolving 3.504 g of indole-3-acetic acid (a molecular weight of 175.18) powder in 10-15 mL of absolute ethanol, adding an obtained indole-3-acetic acid absolute ethanol solution to 20 L of sterilized distilled water, and mixing evenly to obtain 1,000 μM of an IAA solution.

(1) fruits are washed and sterilized: full-size green citrus fruits are collected and washed, they are immersed in a 0.1% bleaching powder solution for 10 min, the fruits are treated with 0.1% of carbendazim for 10 min after air-drying, and then the fruits are rinsed and washed with sterilized water for 5 times, and the fruits are air-dried at room temperature.

(2) the citrus fruits are treated by using a vacuum infiltration method: the fruits are immersed in 1,000 μM of an indole-3-acetic acid solution, the fruits are placed in a vacuum dryer connected to a portable air compressor, the relative vacuum degree of −15 kPa to −20 kPa is set and maintained for 2 min, and then the intake valve is slowly opened, and the indole-3-acetic acid solution is injected into the citrus fruits with an increase of an air pressure.

(3) the fruits are stored: the treated citrus fruits are placed at a dark place at 25±2° C. and a relative humidity of 50-70%.

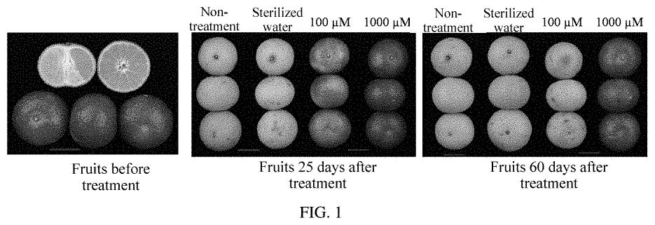

In addition, 1,000 μM of the IAA solution is diluted to obtain 100 μM of the IAA solution, and after the same treatment, citrus fruits respectively subjected to 1) non-treatment, 2) treatment by sterilized water, and 3) treatment by 100 μM of the IAA solution. Citrus fruits before the treatment, treated for 25 days and treated for 60 days are randomly selected and photographed separately, and the citrus fruits are kept in a dark place after the photographs are taken. The photographs of the citrus fruits are shown in FIG. 1. It can be found from FIG. 1 that the citrus fruits treated with 1,000 μM of the IAA solution can keep green color on the 60th day. The citrus fruit coloring retardant of the present disclosure can delay color change of citrus fruits for 2 months or more and is also very fresh.

The above description of the examples is intended to facilitate a person of ordinary skill in the art to understand and use the present disclosure. Obviously, a person skilled in the art can easily make various modifications to these examples, and apply a general principle described herein to other examples without creative efforts. Therefore, the present disclosure is not limited to the examples herein. All improvements and modifications made by a person skilled in the art according to the disclosure of the present disclosure should fall within the protection scope of the present disclosure.

What is claimed is:

1. A citrus fruit coloring retardant, wherein, the citrus fruit coloring retardant is a prepared indole-3-acetic acid solution with a concentration of 100-1,000 μM; and the citrus fruit coloring retardant is prepared by weighing and dissolving indole-3-acetic acid powder in absolute ethanol, adding an obtained indole-3-acetic acid absolute ethanol solution to sterilized distilled water, and mixing evenly to obtain the retardant.

2. The citrus fruit coloring retardant according to claim 1, wherein, a concentration of the indole-3-acetic acid solution is preferably 1,000 μM.

3. A preparation method of the citrus fruit coloring retardant according to claim 2, wherein, the preparation method comprises the following steps:
weighing 3.504 g of indole-3-acetic acid powder and dissolving the indole-3-acetic acid powder in 10-15 mL of absolute ethanol, adding an obtained indole-3-acetic acid absolute ethanol solution to 20 L of sterilized distilled water, and mixing evenly to obtain an indole-3-acetic acid solution with a concentration of 1,000 μM.

4. A method of using the citrus fruit color-changing retardant according to claim 1, wherein, the method comprises the following steps:
(1) after the indole-3-acetic acid solution is prepared, washing and sterilizing fruits: picking full-size green citrus fruits, treating the fruits with a 0.1% bleaching powder solution for 10 min, immersing the fruits in 0.1% of carbendazim for 10 min after air-drying, rinsing the fruits with sterilized water for 5 times, and air-drying the fruits at room temperature;
(2) treating the citrus fruits by using a vacuum infiltration method: immersing the fruits in the indole-3-acetic acid solution, placing the fruits in a vacuum dryer, discharging air in the dryer to a relative vacuum degree of −15 kPa to −20 kPa by a portable air compressor, keeping the vacuum degree for 2 min, slowly opening an intake valve, and enabling the indole-3-acetic acid solution to be injected into the citrus fruits with an increase of an air pressure; and
(3) conducting fruits storage: placing the treated citrus fruits at a dark place at 25±2° C. and a relative humidity of 50-70%.

5. A method of using the citrus fruit coloring retardant according to claim 2, wherein, the method comprises the following steps:
(1) after the indole-3-acetic acid solution is prepared, washing and sterilizing fruits: picking full-size green citrus fruits, treating the fruits with a 0.1% bleaching powder solution for 10 min, immersing the fruits in 0.1% of carbendazim for 10 min after air-drying, rinsing the fruits with sterilized water for 5 times, and air-drying the fruits at room temperature;
(2) treating the citrus fruits by using a vacuum infiltration method: immersing the fruits in the indole-3-acetic acid solution, placing the fruits in a vacuum dryer, discharging air in the dryer to a relative vacuum degree of −15 kPa to −20 kPa by a portable air compressor, keeping the vacuum degree for 2 min, slowly opening an intake valve, and enabling the indole-3-acetic acid solution to be injected into the citrus fruits with an increase of an air pressure; and
(3) conducting fruits storage: placing the treated citrus fruits at a dark place at 25±2° C. and a relative humidity of 50-70%.
